(19) United States
(12) Patent Application Publication
(10) Pub. No.: US 2024/0168965 A1
(43) Pub. Date: May 23, 2024

(54) MACHINE DIAGNOSIS APPARATUS, MACHINE DIAGNOSIS METHOD, AND RECORDING MEDIUM

(71) Applicant: NEC Corporation, Minato-ku, Tokyo (JP)

(72) Inventors: Yoshiaki SAKAE, Tokyo (JP); Hiroki TAGATO, Tokyo (JP); Takashi KONASHI, Tokyo (JP); Jun NISHIOKA, Tokyo (JP); Yuji KOBAYASHI, Tokyo (JP); Jun KODAMA, Tokyo (JP); Etsuko ICHIHARA, Tokyo (JP)

(73) Assignee: NEC Corporation, Minato-ku, Tokyo (JP)

(21) Appl. No.: 18/283,942

(22) PCT Filed: Apr. 2, 2021
(86) PCT No.: PCT/JP2021/014402

§ 371 Date: Sep. 25, 2023

(51) Int. Cl. G06F 16/248; G06F 11/34

(52) U.S. Cl. CPC G06F 16/248; G06F 11/34

(57) ABSTRACT

The present invention reduces the load on a user when performing remote machine diagnosis. An acquisition unit (11) acquires time-series data obtained from equipment of the machine, a prediction unit (12) predicts the state of the machine on the basis of the time-series data, a search unit (13) uses the time-series data as a query to search a knowledge database, storing records of past diagnoses, for knowledge information related to the state of the machine, and a provision unit (14) provides the prediction result and the knowledge information.

### TECHNICAL FIELD

The present invention relates to a machine diagnosis apparatus, a machine diagnosis method, and a recording medium, and relates to, for example, a machine diagnosis apparatus, a machine diagnosis method, and a recording medium for remotely diagnosing a machine based on time-series data received from equipment of the machine.

### BACKGROUND ART

There are related techniques for remotely diagnosing a machine based on time-series data obtained from equipment of the machine.

As an example, PTL 1 provides a diagnosis system that remotely diagnoses an automobile. When the user (driver) feels that the automobile may be broken, the user requests the diagnosis system to diagnose the automobile. The diagnosis system transmits data of the diagnostic program from the information center to the in-vehicle computer. The diagnostic program displays a guidance on the in-vehicle display. The user can specify the cause of the abnormality (or no failure) of the automobile by answering questions from the diagnosis program according to the guidance.

### CITATION LIST

### Patent Literature

PTL 1: JP 2002-331884 A
PTL 2: WO 2020/049666 A1

### SUMMARY OF INVENTION

### Technical Problem

In the related technique described in PTL 1, since the user needs to answer several questions until the diagnosis program can identify the cause of the abnormality, the burden on the user is large.

The present invention has been made in view of the above problem, and an object of the present invention is to reduce a burden on a user in remote machine diagnosis.

### Solution to Problem

A machine diagnosis apparatus according to an aspect of the present invention includes an acquisition means for acquiring time-series data obtained from equipment of a machine, a prediction means for predicting a state of the machine based on the time-series data, a search means for searching for knowledge information related to the state of the machine in a knowledge database that stores a record of past diagnosis using the time-series data as a query, and a provision means for providing a result of the prediction and the knowledge information.

A machine diagnosis method according to an aspect of the present invention includes acquiring time-series data obtained from equipment of a machine, predicting a state of the machine based on the time-series data, searching for knowledge information related to the state of the machine in a knowledge database that stores a record of past diagnosis using the time-series data as a query, and providing a result of the prediction and the knowledge information.

A recording medium according to an aspect of the present invention executing acquiring time-series data obtained from equipment of a machine, predicting a state of the machine based on the time-series data, searching for knowledge information related to the state of the machine in a knowledge database that stores a record of past diagnosis using the time-series data as a query, and providing a result of the prediction and the knowledge information.

### Advantageous Effects of Invention

According to an aspect of the present invention, it is possible to reduce a burden on a user in remote machine diagnosis.

### BRIEF DESCRIPTION OF DRAWINGS

FIG. 1 schematically illustrates an example of a diagnosis system to which a machine diagnosis apparatus according to a first or second example embodiment is applied.

FIG. 2 is a diagram describing functions of an analysis engine included in the diagnosis system illustrated in FIG. 1.

FIG. 3 is a diagram illustrating an example of a data structure of a knowledge database included in the diagnosis system illustrated in FIG. 1.

FIG. 4 is a diagram illustrating an example of a data structure of a data dictionary included in the diagnosis system illustrated in FIG. 1.

FIG. 5 is a block diagram illustrating a configuration of the machine diagnosis apparatus according to the first example embodiment.

FIG. 6 is a flowchart illustrating operations of the machine diagnosis apparatus according to the first example embodiment.

FIG. 7 is a block diagram illustrating a configuration of a machine diagnosis apparatus according to the second example embodiment.

FIG. 8 is a flowchart illustrating operations of the machine diagnosis apparatus according to the second example embodiment.

FIG. 9 is a diagram schematically illustrating a modification of a diagnosis system to which the machine diagnosis apparatus according to the first or second example embodiment is applied.

FIG. 10 is a diagram illustrating an example of time-series data to which comments are added.

FIG. 11 is an explanatory diagram illustrating a flow of learning of the analysis engine illustrated in FIG. 2.

FIG. 12 is a diagram illustrating an example of a hardware configuration of the machine diagnosis apparatus according to any one of the first and second example embodiments.

### EXAMPLE EMBODIMENTS

Some modes for carrying out the present invention will be described below.

(Diagnosis System 1)

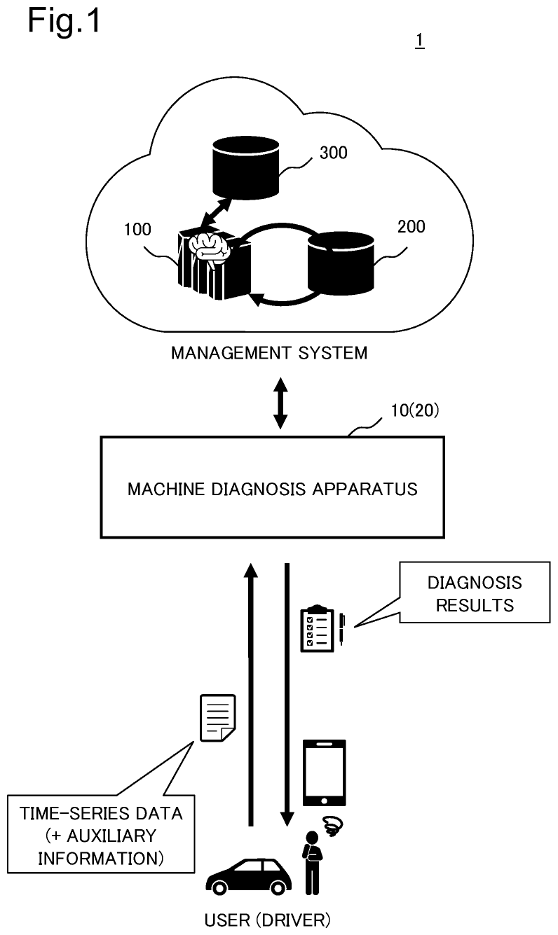

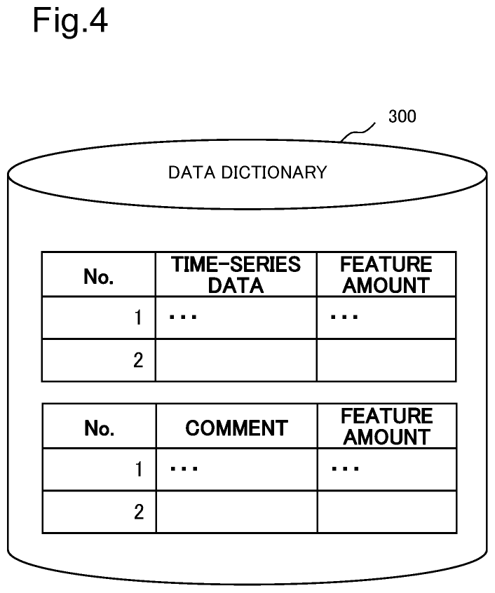

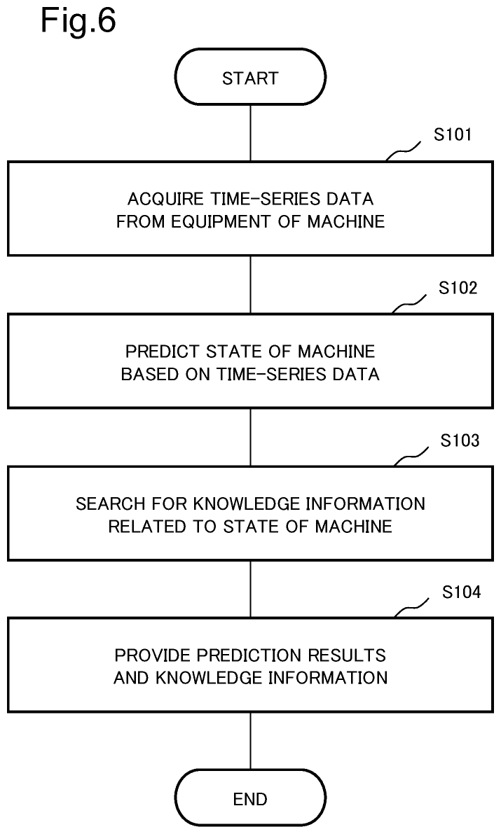

FIG. 1 schematically illustrates an example of a diagnosis system 1 to which a machine diagnosis apparatus 10 (FIG. 4) or a machine diagnosis apparatus 20 (FIG. 6) according to a first or second example embodiment described later is applied. Hereinafter, the “machine diagnosis apparatus 10 or the machine diagnosis apparatus 20” will be referred to as a “machine diagnosis apparatus 10 (20)”.

As illustrated in FIG. 1, the diagnosis system 1 includes the machine diagnosis apparatus 10 (20), an analysis engine 100, a knowledge database 200, and a data dictionary 300. Hereinafter, the knowledge database 200 may be referred to as knowledge DB 200.

The machine diagnosis apparatus 10 (20) remotely diagnoses a machine based on time-series data obtained from equipment of the machine. The machine is an industrially applicable device that operates by converting a power source such as electric power or fuel into motive power. For example, the machine is an automobile, a ship, an agricultural machine, an industrial machine, an unmanned aerial vehicle, or a personal airplane. Hereinafter, an automobile will be described as an example.

The equipment of the machine is equipment, a device, an apparatus, or a combination thereof included in the machine. The equipment of the machine outputs time-series data continuously or intermittently. In one example, the time-series data is sensor data output from various sensors. For example, in the case of an automobile, an engine and a motor, various auxiliary devices such as a power window, a seat belt, a door lock, a fuel gauge, a wiper, a fog lamp, an air conditioner, and an indoor light, output sensor data.

The machine diagnosis apparatus 10 (20) analyzes the time-series data obtained from the equipment of the machine by using the analysis engine 100. The machine diagnosis apparatus 10 (20) diagnoses the state of the machine based on the analysis result of the time-series data. Thereafter, the machine diagnosis apparatus 10 (20) transmits diagnostic results indicating whether there is an indication of a failure in the machine or whether an inspection is necessary, to the machine, the user device, or the like.

The user (driver) determines whether to keep riding on the automobile or bring the automobile to the dealer based on the diagnostic results transmitted from the machine diagnosis apparatus 10 (20).

(Analysis Engine 100)

The analysis engine 100 includes a computer program such as a long short-term memory (LSTM) in which feature amounts of normal time-series data and feature amounts of abnormal time-series data are learned by machine learning. The analysis engine 100 further includes a processor that executes the computer program, a memory, and computer hardware such as an interface. The analysis engine 100 analyzes the time-series data input by the machine diagnosis apparatus 10 (20), searches for comments having feature amounts similar to the feature amounts of the time-series data, and outputs search results. For example, the analysis engine 100 searches for comments having feature amounts similar to the feature amounts of the time-series data based on a known similarity concept such as a Euclidean distance in the feature vector space. The comment is text data representing the state of the machine implied by the time-series data.

The analysis engine 100 returns search results having a data format different from the query. This can be enabled by a technique of training a computer program (such as LSTM) such that the position of a feature amount extracted from a certain segment of time-series data and the position of a feature amount extracted from text data related to the segment of time-series data are close to each other in a feature amount space to associate the time-series data and the text data with each other. For example, a section of the time-series data where the rotation speed of the engine is rapidly increased is associated with a comment (text data) such as “the engine has been raced with the lever in the neutral position”.

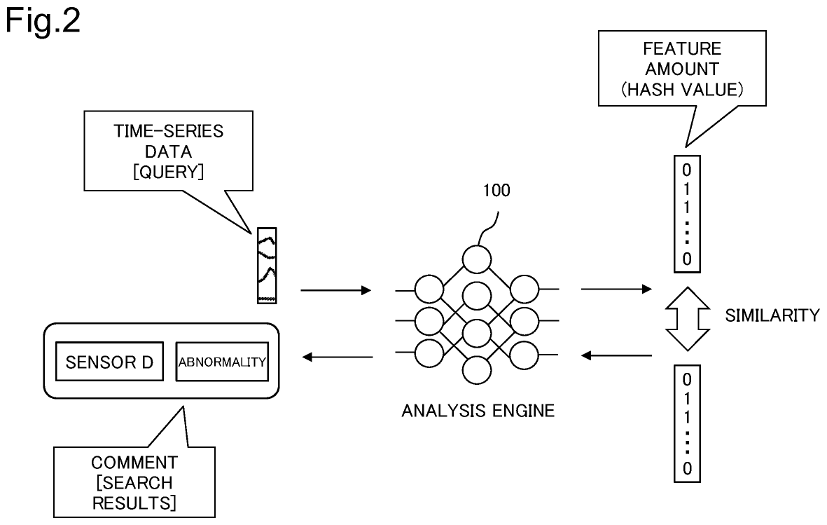

FIG. 2 is a diagram describing functions of the analysis engine 100 included in the diagnosis system 1 (FIG. 1). As described above, the time-series data is input to the analysis engine 100 as a search query. The analysis engine 100 extracts a feature amount from the input time-series data. The analysis engine 100 searches the data dictionary 300 (FIG. 4) for a comment having a feature amount similar to the feature amount of the time-series data. Then, the analysis engine 100 outputs a comment as a search result.

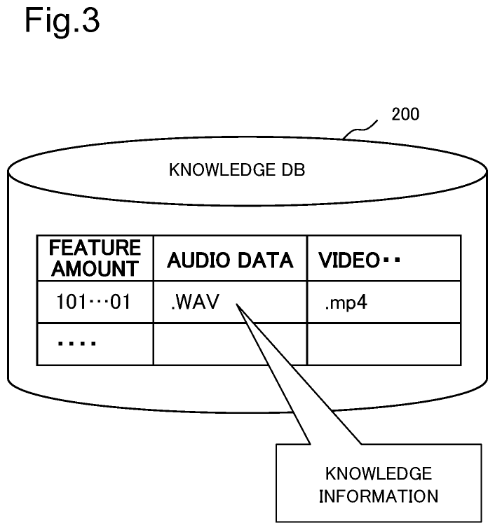

(Knowledge DB 200) FIG. 3 illustrates an example of a data structure of the knowledge DB 200 included in the diagnosis system 1 (FIG. 1). As illustrated in FIG. 3, the knowledge DB 200 stores knowledge information associated with feature amounts or their hash values. In the example illustrated in FIG. 3, the knowledge information includes audio data and video data. However, the knowledge information is not limited thereto. The knowledge information is related to the state of the machine implied by the feature amounts of the time-series data, and is provided from the diagnosis system 1 to the user. The knowledge information includes any content data and any text data. For example, the knowledge information is a video representing a measure for checking the state of the machine (such as “performing a specific operation on the machine”). Alternatively, the knowledge information is text data of a comment (“sensor has failed” or the like) representing the state of the machine.

Auxiliary information (FIG. 1) may be attached to the time-series data transmitted from the automobile to the machine diagnosis apparatus (20). The auxiliary information attached to the time-series data is stored in the knowledge DB 200 as knowledge information. The auxiliary information stored in the knowledge DB 200 as knowledge information is provided from the diagnosis system 1 to the user as knowledge information related to the state of the machine at the time of another diagnosis later. The auxiliary information is perceived by the user using five senses or intuition or is acquired by using the user device. The auxiliary information may be structured data or unstructured data. The content of the auxiliary information is not limited.

The auxiliary information includes content data generated by the user device. The auxiliary information includes text data describing the user's perception. The auxiliary information may be structured data such as acceleration data output from a gyro sensor of a smartphone.

Alternatively, the auxiliary information may be unstructured data such as voice data input by the user to a microphone or text data input by the user to a smartphone.

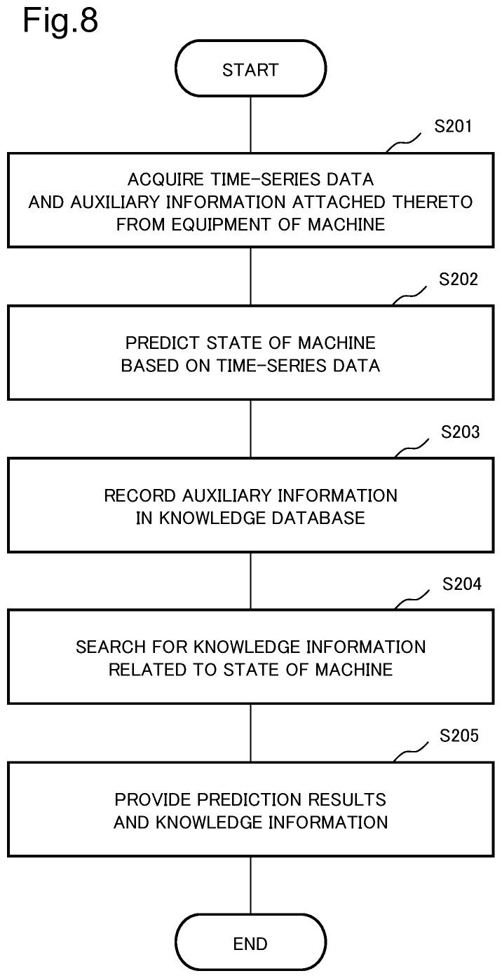

As described later in a modification (FIG. 8), text data indicating the state of the automobile (machine) implied by the time-series data, such as findings, symptoms, and countermeasures, is transmitted to the management system from a dealer who handled the inspection and repair of the automobile. The text data is stored in the data dictionary 300 described later as comments related to the time-series data.

(Data Dictionary 300)

FIG. 4 is a diagram illustrating an example of a data structure in the data dictionary 300. As illustrated in FIG. 4, the data dictionary 300 stores correlated time-series data and comments in association with feature amounts. The term “corelated” herein means that the position of the feature amount of the time-series data and the position of the feature amount of the comment in the feature amount space are close to each other, that is, the feature amounts are similar to each other. The time-series data and the comments are classified into one of a normal (no abnormality) group and a group with abnormality or its sign for each type of abnormality. More specifically, time-series data and comments obtained from equipment of an automobile in which a certain sensor is in a normal state are classified into a normal group related to the sensor in the data dictionary 300. On the other hand, time-series data and comments obtained from equipment of an automobile in which a certain sensor is in an abnormal state are classified into an abnormal group related to the sensor in the data dictionary 300.

In relation to the following first and second example embodiments, a case where the diagnosis target is an automobile will be described. However, the diagnosis target is not limited to an automobile. The diagnosis target may be an automobile or may be a machine such as a ship, an agricultural machine, an industrial machine, an unmanned aerial vehicle, or a private airplane.

### First Example Embodiment

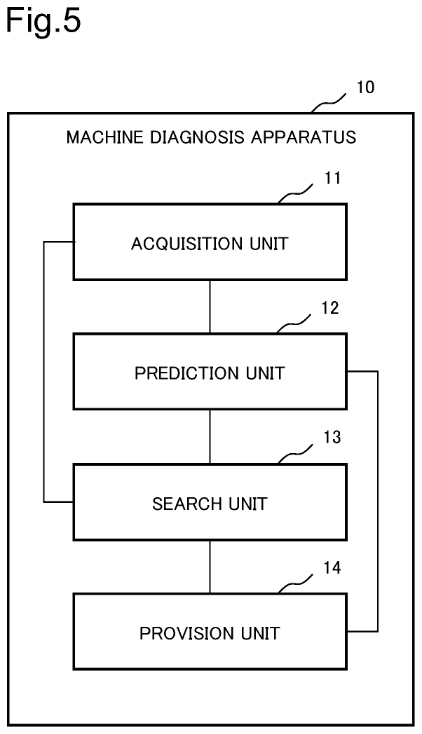

The first example embodiment will be described with reference to FIGS. 5 and 6.

(Machine Diagnosis Apparatus 10)

FIG. 5 is a block diagram illustrating a configuration of the machine diagnosis apparatus 10 according to the first example embodiment. As illustrated in FIG. 5, the machine diagnosis apparatus includes an acquisition unit 11, a prediction unit 12, a search unit 13, and a provision unit 14.

The acquisition unit 11 acquires time-series data obtained from equipment of a machine (an automobile herein). The acquisition unit 11 is an example of an acquisition means.

In one example, the acquisition unit 11 acquires output data of an engine control unit (ECU), sensor data, and/or other time-series data from the equipment of the user's automobile via an arbitrary wireless network such as a mobile network. The time-series data is acquired to measure the state of a drive system in the automobile or the state of auxiliary equipment in the automobile. The acquisition unit 11 outputs the acquired time-series data to the prediction unit 12 and the search unit 13.

Further, auxiliary information attached to the time-series data may be transmitted from the equipment of the user's automobile (for example, a car navigation device or a touch panel display device) or a user device (for example, a smartphone). In this case, the acquisition unit 11 also acquires the auxiliary information attached to the time-series data together with the time-series data. The acquisition unit 11 then outputs the time-series data and the auxiliary information to a recording unit (not illustrated) (second example embodiment).

The prediction unit 12 predicts the state of the machine based on the time-series data. The prediction unit 12 is an example of a prediction means.

In one example, the prediction unit 12 inputs the time-series data as a query to the analysis engine 100 (FIG. 2) that has learned the feature amounts of the normal time-series data and the feature amounts of the abnormal time-series data by machine learning, and receives prediction results as search results.

First, the prediction unit 12 receives the time-series data from the acquisition unit 11. The prediction unit 12 inputs the time-series data to the analysis engine 100.

As described above, the analysis engine 100 extracts the feature amounts of the input time-series data, and searches the data dictionary 300 (FIG. 4) for a comment (text data) having a similar feature amount. In the data dictionary 300, correlated time-series data and comments are classified into a normal group or a group with abnormality or its sign for each type of abnormality (for example, for each sensor). The analysis engine 100 outputs a comment belonging to one of the normal group and the abnormal group in the data dictionary 300.

The prediction unit 12 predicts the state of the automobile based on whether the comment output from the analysis engine 100 belongs to the normal group or the abnormal group in the data dictionary 300. Specifically, if the comment output from the analysis engine 100 belongs to the normal group in the data dictionary 300, the prediction unit 12 predicts that the automobile is normal.

On the other hand, if the comment output from the analysis engine 100 belongs to the abnormal group in the data dictionary 300, the prediction unit 12 predicts that the automobile is abnormal.

Alternatively, the prediction unit 12 may predict the state of the automobile by analyzing the comment output from the analysis engine 100. For example, if the output comment includes a word of “stable” or a synonym thereof, the prediction unit 12 predicts that the automobile is normal. On the other hand, if the output comment includes a word of “abnormal” or a synonym thereof, it is predicted that the automobile has an abnormality. The prediction unit 12 outputs the comment output from the analysis engine 100 to the provision unit 14 together with the prediction result.

The search unit 13 searches for knowledge information on the abnormality of the machine in the knowledge DB 200 storing the record of the past diagnosis, using the time-series data as a query. The search unit 13 is an example of a search means.

In one example, the search unit 13 receives the time-series data from the acquisition unit 11. The search unit 13 inputs the time-series data to the analysis engine 100 (FIG. 2). The search unit 13 acquires data of the feature amounts extracted from the time-series data by the analysis engine 100. The search unit 13 then searches the knowledge DB 200 (FIG. 3) for knowledge information associated with feature amounts similar to the feature amounts of the time-series data. The search unit 13 outputs the knowledge information obtained as search results to the provision unit 14.

The provision unit 14 provides prediction results and knowledge information. The provision unit 14 is an example of a provision means.

In one example, the provision unit 14 receives prediction results (and comments) from the prediction unit 12. The provision unit 14 also receives the knowledge information obtained as search results from the search unit 13. The provision unit 14 outputs the prediction results and the knowledge information to a processing unit (not illustrated) in a subsequent stage. Alternatively, the provision unit 14 transmits the prediction results and the knowledge information to the equipment of the automobile (for example, a car navigation device or a display device) or a user device (for example, a smartphone) via an arbitrary wireless network such as a mobile network.

In a case where the knowledge information is a video, the provision unit 14 may display the knowledge information on a screen of a car navigation device or a smartphone. Alternatively, in a case where the knowledge information is voice data, the provision unit 14 may output the knowledge information by voice from a speaker included in the automobile or the user device.

(Operations of Machine Diagnosis Apparatus 10)

The operations of the machine diagnosis apparatus 10 according to the first example embodiment will be described with reference to FIG. 6. FIG. 6 is a flowchart illustrating a flow of a process executed by individual units of the machine diagnosis apparatus 10.

First, the user (driver) turns on a diagnosis button installed in the automobile in advance to start on-demand diagnosis. The press of the diagnosis button is notified from the diagnosis button to the machine diagnosis apparatus 10. The diagnosis button may be an in-vehicle device.

Alternatively, instead of pressing the diagnosis button, the user may input a voice to a microphone or use a smartphone application. After the user turns on the diagnosis button, voice artificial intelligence (AI) or a chatbot may perform a simple interview with the user.

Thereafter, the machine diagnosis apparatus 10 starts remote diagnosis as described below.

As illustrated in FIG. 6, the acquisition unit 11 acquires time-series data obtained from the equipment of the machine (S101).

Next, the prediction unit 12 predicts the state of the machine based on the time-series data (S102).

The search unit 13 searches for knowledge information related to the state of the machine in the knowledge DB 200 storing records of the past diagnosis, using the time-series data as a query (S103).

The provision unit 14 provides the prediction results and the knowledge information to the user by transmitting the prediction results and the knowledge information to the equipment of the automobile or the user device (S104).

As described above, the operations of the machine diagnosis apparatus 10 according to the first example embodiment ends.

### Advantageous Effects of Present Example Embodiment

According to the configuration of the present example embodiment, the acquisition unit 11 acquires time-series data obtained from equipment of a machine. The prediction unit 12 predicts the state of the machine based on the time-series data. The search unit 13 searches for knowledge information related to the state of the machine in the knowledge database storing records of the past diagnosis, using the time-series data as a query. The provision unit 14 provides prediction results and knowledge information. The user can obtain the knowledge information together with the prediction results without replying to a large number of questions. For example, the user obtains a video about a measure for checking the state of the machine as the knowledge information. The user checks if the machine is normal with reference to the content of the video (knowledge information). This makes it possible to reduce a burden on the user in remote machine diagnosis.

### Second Example Embodiment

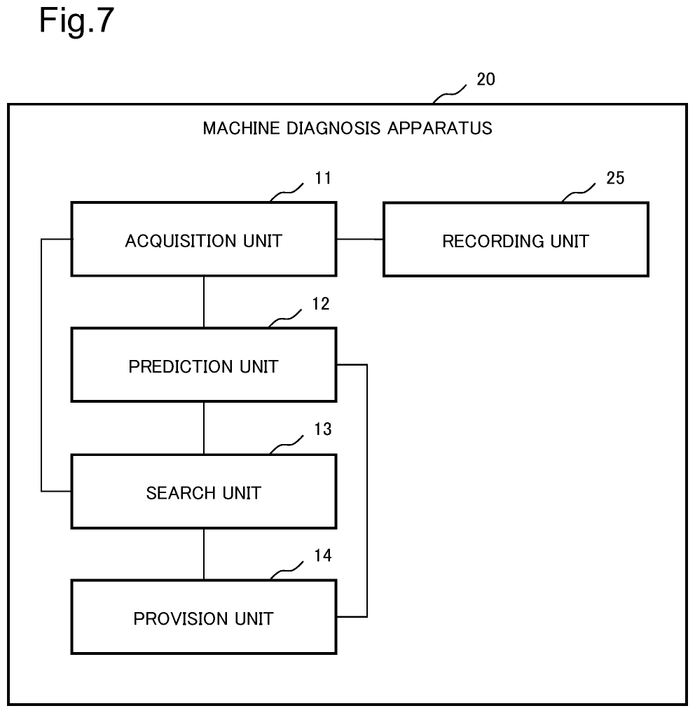

The second example embodiment will be described with reference to FIGS. 7 and 8. In the second example embodiment, how to expand the knowledge DB 200 (FIG. 3) of the diagnosis system 1 (FIG. 1) will be described.

(Machine Diagnosis Apparatus 20)

FIG. 7 is a block diagram illustrating a configuration of a machine diagnosis apparatus 20 according to the second example embodiment. As illustrated in FIG. 7, the machine diagnosis apparatus 20 includes an acquisition unit 11, a prediction unit 12, a search unit 13, and a provision unit 14. The machine diagnosis apparatus 20 further includes a recording unit 25.

The recording unit 25 stores the data of feature amounts extracted from time-series data by an analysis engine or hash values thereof in a knowledge database in association with auxiliary information. The recording unit 25 is an example of a recording means. The recording unit 25 receives the time-series data and the auxiliary information from the acquisition unit 11. The recording unit 25 inputs the received time-series data to an analysis engine 100 (FIG. 2). The recording unit 25 acquires data of the feature amounts extracted from the time-series data by the analysis engine 100. The recording unit 25 associates the data of the feature amounts of the time-series data with the auxiliary information attached to the time-series data. The recording unit 25 then stores the data of the feature amounts and the auxiliary information in the knowledge DB 200.

(Operations of Machine Diagnosis Apparatus 20)

The operations of the machine diagnosis apparatus 20 according to the second example embodiment will be described with reference to FIG. 8. FIG. 8 is a flowchart illustrating a flow of a process executed by individual units of the machine diagnosis apparatus 20.

As in the first example embodiment, the user (driver) turns on a diagnosis button installed in the automobile in advance to start on-demand diagnosis. Thereafter, the machine diagnosis apparatus 20 starts remote diagnosis as described below.

As illustrated in FIG. 8, the acquisition unit 11 acquires time-series data obtained from equipment of a machine and auxiliary information attached to the time-series data (S201). For example, the auxiliary information includes content data generated by a user device such as a smartphone. In other examples, the auxiliary information includes text data describing the user's perception.

Next, the prediction unit 12 predicts the state of the machine based on the time-series data (S202).

The recording unit 25 stores the auxiliary information associated with the feature amounts of the time-series data in the knowledge DB (FIG. 3) (S203). If the auxiliary information is not attached to the time-series data, the recording unit 25 skips step S203.

The search unit 13 searches for knowledge information related to the state of the machine in the knowledge DB 200 storing records of the past diagnosis, using the time-series data as a query (S204).

The provision unit 14 provides the prediction results and the knowledge information to the user by transmitting the prediction results and the knowledge information to the equipment of the automobile or the user device (S205).

As described above, the operations of the machine diagnosis apparatus 20 according to the second example embodiment ends.

### Advantageous Effects of Present Example Embodiment

According to the configuration of the present example embodiment, the acquisition unit 11 acquires time-series data obtained from equipment of a machine. The prediction unit 12 predicts the state of the machine based on the time-series data. The search unit 13 searches for knowledge information related to the state of the machine in the knowledge database storing records of the past diagnosis, using the time-series data as a query. The provision unit 14 provides prediction results and knowledge information. The user can obtain the knowledge information together with the prediction results without replying to a large number of questions. For example, the user obtains a video about a measure for checking the state of the machine as the knowledge information. The user checks if the machine is normal with reference to the content of the video (knowledge information). This makes it possible to reduce a burden on the user in remote machine diagnosis.

According to the configuration of the present example embodiment, the recording unit 25 stores the data of the feature amounts or the hash values thereof extracted from the time-series data by the analysis engine in the knowledge database in association with the auxiliary information. The auxiliary information saved in the knowledge database is referred to as knowledge information in future diagnosis. In this way, the knowledge database can be expanded.

(Modification)

In a modification of the first and second example embodiment, the machine diagnosis apparatus 10 (20) introduces dealer candidates to a user (driver) in order to inspect an automobile.

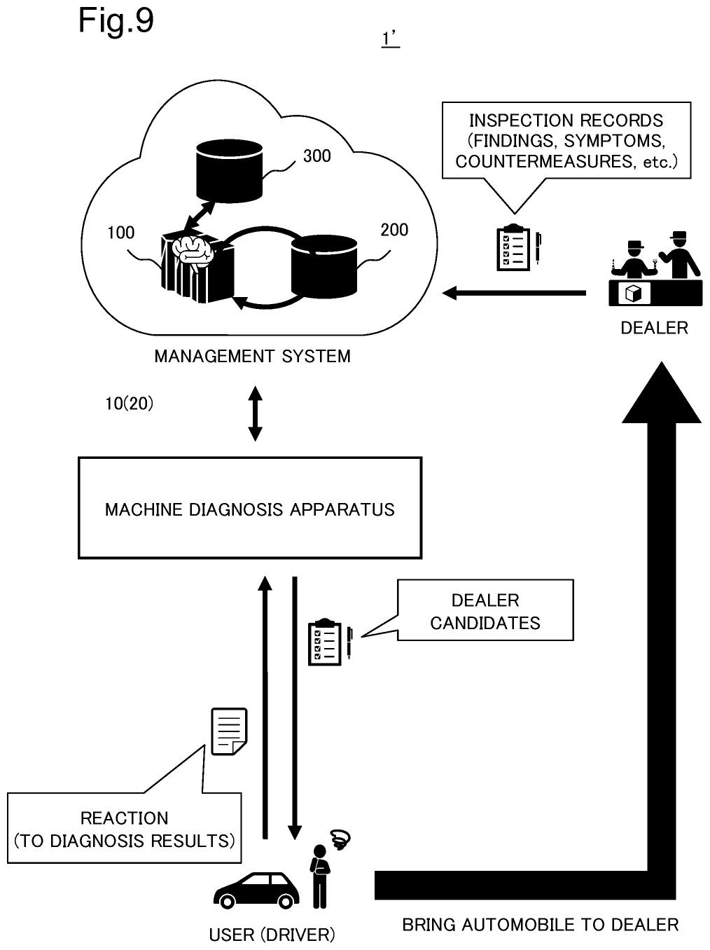

FIG. 9 schematically illustrates a modification of the diagnosis system 1 illustrated in FIG. 1 (referred to as “diagnosis system 1′”). As illustrated in FIG. 9, a machine diagnosis apparatus 10 (20) of the diagnosis system 1′ according to the present modification provides a diagnostic result and then receives a reaction indicating appropriateness of the diagnostic result from the user. In one example, the machine diagnosis apparatus 10 (20) receives a reaction from a car navigation apparatus or a smartphone including information indicating appropriateness of the diagnostic result.

The machine diagnosis apparatus 10 (20) responds differently depending on the contents of the reaction.

Specifically, if (1) the diagnostic result indicates that there is an abnormality in the automobile and a reaction showing appropriateness of the diagnostic result is received, the machine diagnosis apparatus 10 (20) provides the user with information on dealer candidates listed in a normal list.

On the other hand, if (2) the diagnostic result indicates that there is an abnormality in the automobile and a reaction showing non-appropriateness of the diagnostic result is received, the machine diagnosis apparatus 10 (20) provides the user with information on high-level dealer candidates capable of performing an inspection with a high level of difficulty.

On the other hand, if (3) the diagnostic result indicates that there is no abnormality in the automobile and a reaction showing appropriateness of the diagnostic result is received, the machine diagnosis apparatus 10 (20) does not provide the user with information on dealer candidates. Instead, the machine diagnosis apparatus 10 (20) transitions from an on-demand diagnosis mode to a continuous diagnosis mode. In the continuous diagnosis mode, the machine diagnosis apparatus 10 (20) executes diagnosis of the automobile periodically or at a predetermined timing without receiving a request for on-demand diagnosis from the user (that is, without turning on the diagnosis button by the user).

In the case (1) or (2), the user brings the automobile to the dealer.

The dealer inspects the automobile and repairs the automobile if necessary. The dealer sends an inspection record including information such as findings, symptoms, countermeasures, etc. related to the inspection of the automobile to the management system or the machine diagnosis apparatus 10 (20). The inspection record transmitted from the dealer is stored in a knowledge DB 200 (FIG. 3) in association with the data of feature amounts of the time-series data or the hash values (indexes) thereof.

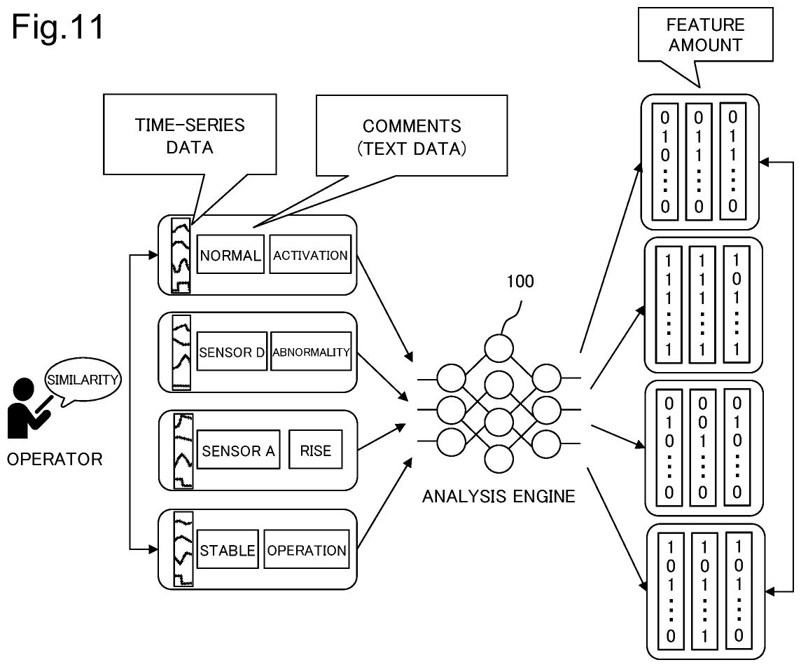

Alternatively, the machine diagnosis apparatus 10 (20) may generate comments from the inspection record. The comment is text data representing the state of the machine implied by the time-series data. For example, the machine diagnosis apparatus 10 (20) extracts a description of the symptoms and countermeasures from the inspection record to generate comments on the symptoms and countermeasures. Then, the machine diagnosis apparatus 10 (20) saves the generated comments (text data) in a data dictionary 300 (FIG. 4) in association with the time-series data. The comments saved in the data dictionary 300 can be used for learning (FIG. 11) of an analysis engine 100.

(Supplement: Learning of Analysis Engine 100)

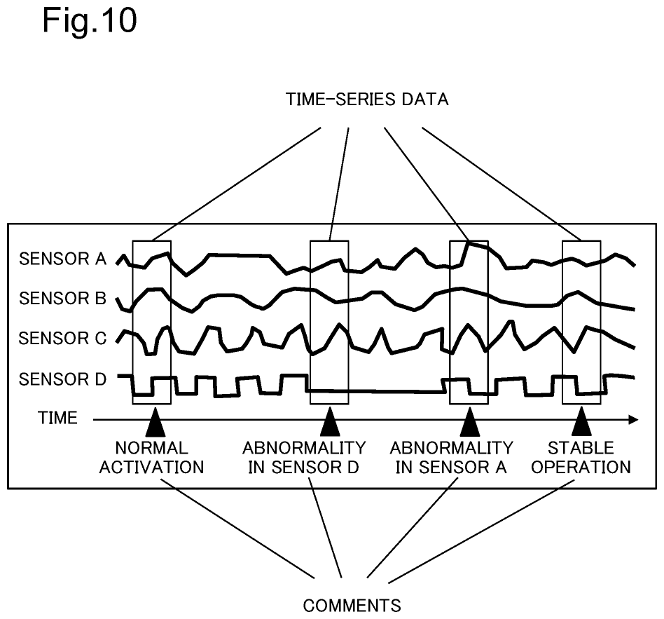

Learning of the analysis engine 100 included in the diagnosis system 1 (FIG. 1) or the diagnosis system 1′ (FIG. 9) will be described with reference to FIGS. 10 and 11. The learning of the analysis engine 100 requires time-series data and comments indicating the state of the machine implied by the time-series data.

FIG. 10 is a diagram illustrating an example of time-series data to which comments are added. Herein, it is assumed that the time-series data is four pieces of sensor data obtained from the four sensors A to D. In the example illustrated in FIG. 10, different comments are added to four pieces of segment data of a predetermined time width cut out from the time-series data at different times. For example, a comment “normal+operation” is added to the segment data at the left end. This indicates that the time-series data implies that all four sensors A to D are operating normally.

FIG. 11 is an explanatory diagram illustrating a flow of learning of the analysis engine 100. As illustrated in FIG. 11, pluralities of pieces of correlated time-series data and comments (text data) are prepared. The correlated time-series data and comments are not limited to a one-to-one set. One or more pieces of time-series data and one or more comments may be linked (associated) with each other. First, the time-series data is input to the analysis engine 100. The analysis engine 100 outputs the feature amounts of the input time-series data. Next, comments related to the previously input time-series data are input to the analysis engine 100.

The analysis engine 100 outputs the feature amounts of the input comments. In this way, the feature amounts of the time-series data and the feature amounts of the comments related to each other are obtained. The operator causes the analysis engine 100 to learn in such a way as to bring the feature amounts of the time-series data close to the feature amounts of the comments. For example, the operator causes the analysis engine 100 to learn in such a way as to maximize the similarity between the feature amounts of the time-series data and the feature amounts of the comments.

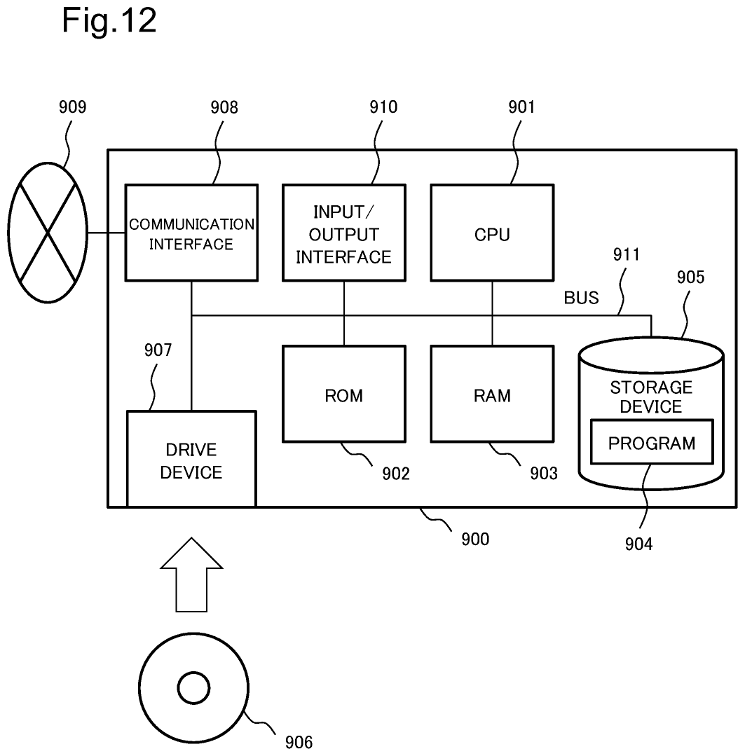

The learning of the analysis engine 100 is completed by repeating the above procedure for the correlated time-series data and comments. As described with reference to FIG. 2, when the time-series data is input as a query, the analysis engine 100 that has completed learning can return comments as search results.

[Hardware Configuration] Each component of the machine diagnosis apparatus 10, 20 in the first and second example embodiments described above represents a functional unit block. Some or all of these components are implemented by an information processing apparatus 900 as illustrated in FIG. 12, for example. FIG. 12 is a block diagram illustrating an example of a hardware configuration of the information processing apparatus 900.

As illustrated in FIG. 12, the information processing apparatus 900 includes the following components as an example.
Central processing unit (CPU) 901
Read only memory (ROM) 902
Random access memory (RAM) 903
Program 904 loaded into RAM 903
Storage device 905 storing program 904
Drive device 907 that reads and writes recording medium 906
Communication interface 908 connected to communication network 909
Input/output interface 910 for inputting/outputting data
Bus 911 connecting the components

Each component of the machine diagnosis apparatus 10, 20 in the first and second example embodiments described above is implemented by the CPU 901 reading and executing the program 904 for implementing these functions. The program 904 for implementing the function of each component is stored in the storage device 905 or the ROM 902 in advance, for example, and the CPU 901 loads the program into the RAM 903 and executes the program as necessary. The program 904 may be supplied to the CPU 901 via the communication network 909, or may be stored in advance in the recording medium 906, and the drive device 907 may read the program and supply the program to the CPU 901.

According to the above configuration, the machine diagnosis apparatuses 10, 20 in the first and second example embodiments described above are implemented as hardware. Therefore, advantageous effects similar to the advantageous effects in the first and second example embodiments can be obtained.

### [Supplementary Notes]

One aspect of the present invention is also described as the following supplementary notes, but is not limited to the following supplementary notes.

(Supplementary Note 1)

A machine diagnosis apparatus including
an acquisition means that acquires time-series data obtained from equipment of a machine,
a prediction means that predicts a state of the machine based on the time-series data,
a search means that searches for knowledge information related to the state of the machine in a knowledge database that stores a record of past diagnosis using the time-series data as a query, and
a provision means that provides a result of the prediction and the knowledge information.

(Supplementary Note 2)

The machine diagnosis apparatus according to Supplementary Note 1, wherein
the prediction means inputs the time-series data as a query to an analysis engine that has learned by machine learning a feature amount of normal time-series data and a feature amount of abnormal time-series data, and receives the result of the prediction as a search result.

(Supplementary Note 3)

The machine diagnosis apparatus according to Supplementary Note 1 or 2, wherein
the acquisition means acquires auxiliary information attached to the time-series data together with the time-series data.

(Supplementary Note 4)

The machine diagnosis apparatus according to Supplementary Note 3, wherein
the auxiliary information includes content data generated by a user device.

(Supplementary Note 5)

The machine diagnosis apparatus according to Supplementary Note 3 or 4, wherein
the auxiliary information includes text data describing user's perception.

(Supplementary Note 6)

The machine diagnosis apparatus according to any one of Supplementary Notes 3 to 5, further including
a recording means that stores data of the feature amount extracted from the time-series data or a hash value of the feature amount in the knowledge database in association with the auxiliary information.

(Supplementary Note 7)

The machine diagnosis apparatus according to any one of Supplementary Notes 1 to 6, wherein
the result of the prediction includes a comment on the state of the machine.

(Supplementary Note 8)

The machine diagnosis apparatus according to any one of Supplementary Notes 1 to 7, wherein
the provision means provides the knowledge information via a platform of a third party.

(Supplementary Note 9)

A machine diagnosis method including
acquiring time-series data obtained from equipment of a machine,
predicting a state of the machine based on the time-series data,
searching for knowledge information related to the state of the machine in a knowledge database that stores a record of past diagnosis using the time-series data as a query, and
providing a result of the prediction and the knowledge information.

(Supplementary Note 10)

A non-transitory recording medium storing a program for causing a computer to execute
acquiring time-series data obtained from equipment of a machine,
predicting a state of the machine based on the time-series data,
searching for knowledge information related to the state of the machine in a knowledge database that stores a record of past diagnosis using the time-series data as a query, and
providing a result of the prediction and the knowledge information.

### INDUSTRIAL APPLICABILITY

The present invention can be used for a machine diagnosis apparatus that remotely diagnoses a machine such as an automobile, a ship, an agricultural machine, an industrial machine, an unmanned aerial vehicle, or a private airplane, for example.

### REFERENCE SIGNS LIST

1 Diagnosis system
1′ Diagnosis system
10 Machine diagnosis apparatus
11 Acquisition unit
12 Prediction unit
13 Search unit
14 Provision unit
20 Machine diagnosis apparatus
25 Recording unit
100 Analysis engine
200 Knowledge database (DB)

What is claimed is:

1. A machine diagnosis apparatus comprising:
a memory configured to store instructions; and
at least one processor configured to execute the instructions to perform:
acquire time-series data obtained from equipment of a machine;
predict a state of the machine based on the time-series data;
search for knowledge information related to the state of the machine in a knowledge database that stores a record of past diagnosis using the time-series data as a query; and
provide a result of the prediction and the knowledge information.

2. The machine diagnosis apparatus according to claim 1, wherein
the at least one processor is configured to execute the instructions to perform:
inputting the time-series data as a query to an analysis engine that has learned by machine learning a feature amount of normal time-series data and a feature amount of abnormal time-series data, and receives the result of the prediction as a search result.

3. The machine diagnosis apparatus according to claim 1, wherein
the at least one processor is configured to execute the instructions to perform:
acquiring auxiliary information attached to the time-series data together with the time-series data.

4. The machine diagnosis apparatus according to claim 3, wherein
the auxiliary information includes content data generated by a user device.

5. The machine diagnosis apparatus according to claim 3, wherein
the auxiliary information includes text data describing user's perception.

6. The machine diagnosis apparatus according to claim 3, further comprising
storage configured to store data of the feature amount extracted from the time-series data or a hash value of the feature amount in the knowledge database in association with the auxiliary information.

7. The machine diagnosis apparatus according to claim 1, wherein
the result of the prediction includes a comment on the state of the machine.

8. The machine diagnosis apparatus according to claim 1, wherein
the at least one processor is configured to execute the instructions to perform:
providing the knowledge information via a platform of a third party.

9. A machine diagnosis method comprising:
acquiring time-series data obtained from equipment of a machine;
predicting a state of the machine based on the time-series data;
searching for knowledge information related to the state of the machine in a knowledge database that stores a record of past diagnosis using the time-series data as a query; and
providing a result of the prediction and the knowledge information.

10. A non-transitory recording medium storing a program for causing a computer to execute:
acquiring time-series data obtained from equipment of a machine;
predicting a state of the machine based on the time-series data;
searching for knowledge information related to the state of the machine in a knowledge database that stores a record of past diagnosis using the time-series data as a query; and
providing a result of the prediction and the knowledge information.
